(19) United States
(12) Patent Application Publication
(10) Pub. No.: US 2011/0294041 A1
(43) Pub. Date: Dec. 1, 2011

(54) SOLID OXIDE FUEL CELL WITH SPECIAL CELL GEOMETRY

(76) Inventors: Sascha Kuehn, Dresden (DE); Katrin Klein, Dresden (DE); Buchinger Gerhard, Wels (AU)

(21) Appl. No.: 12/998,886

(22) PCT Filed: Dec. 14, 2009
(86) PCT No.: PCT/EP2009/008952

§ 371 Date: Aug. 11, 2011

(30) Foreign Application Priority Data
Dec. 12, 2008 (DE) 10 2008 064 030.1

(51) Int. Cl. H01M 4/86; H01M 8/04

(52) U.S. Cl. 429/512; 429/523; 429/529; 429/532

(57) ABSTRACT

A solid oxide fuel cell, wherein one of the electrodes of the fuel cell or an electrically conductive carrier, on which this electrode is applied, is designed as stabilizing substrate (1), in which multiple tubular hollows with preferably round, oval and/or square cross sections and with at least one open end are arranged, wherein the hollows are coated with at least an electrolyte (2) and at least the other, second electrode (3) of the fuel cell, and wherein at least one constructional element, hereinafter also denoted as constructional feature, is arranged on or at and/or integrated into the substrate, said constructional element being adapted for the integration of the fuel cell into a reactor.

This invention refers to a solid oxide fuel cell, in which according to the present invention the stabilizing substrate is an electrode or an electrically conducting carrier, which is characterised by multiple tubular hollows and at least one construction feature simplifying the integration of the fuel cell into a stack.

State of technology (prior art): Already existing concepts for high-temperature solid oxide fuel cells are documented in the technical literature. (See Fuel Cell Handbook 7th edition, EG&G Services, Inc. U.S. Department of Energy, Office of Fossil Energy, National Energy Technology Laboratory, Morgantown, West Virginia, November 2004; Handbook of Fuel Cells Fundamentals, Technology and Application, Wolf Vielstich, Hubert A. Gasteiger, Arnold Lamm, 2003 John Wiley & Sons, Ltd.).

In known cells the integration into a stack as well as cell power output are especially problematic, whereas a stack defines the electrical and gas-related combination of individual fuel cells to a reactor unit. In known cell geometries especially in tubular cells, large losses occur often especially at the transition from the cell to the stack materials due to poor electrically conducting transitions and/or not continuous connections between cell and stack.

Therefore, the challenge of this invention is to improve the possibilities for integration into a stack and thereby to minimize the losses at the transitions between the cell and the stack materials and thus and due to improved geometry of the cell structure as well, to increase the cell power rating.

This aim is achieved by a fuel cell system according to claim 1. Other advantageous design forms of a fuel cell system according to the present invention can be found in the depending claims.

The individual characteristics of the design examples, which are described in the following, can be realized independently from each other within the scope of the present invention, thus do not have to be exactly implemented in the characteristics combinations presented in the examples.

A fuel cell according to the present invention is a solid oxide fuel cell, where one of the electrodes or an electrical carrier is designed as stabilizing substrate, in which multiple tubular hollows with at least one open end are arranged. Thereby the hollows are coated with at least the electrolyte and at least the second electrode and at least one design element (subsequently also called a design feature) is arranged/integrated on/into the substrate for the integration of the fuel cell into a stack.

The hollows lead to an increase of the three-phase boundary and thus to an improved power rating of the high-temperature solid oxide fuel cells. The hollow diameter is favourably between 0.1 mm and 3 cm. The number of hollows per area can be flexibly adjusted according to their size; a substrate area vs. hollows area ratio of 2:1 to 5:1 is favourable. Beyond that, electrical losses as well as sealing problems are favourably minimized due to better possibilities of integration into a stack by the application of appropriately suitable design features. As described in the following, such design features can be for example threads, extensions or recesses.

Attached inner or outer threads allow form-fitting connections according to the present invention and thus simplify sealing of the connections between cell and stack. If, in addition the thread consists of an electrically conducting material, then the electrical losses at the transition from cell to stack are minimised.

Extensions suitable to attach clamp-connections and/or plug-connections to the stack, can according to the present invention improve the possibilities for integration of the fuel cell into the stack, as those connection features allow accurately fitting transitions.

Another possibility according to the present invention are extensions suitable to simplify adhesive, solder and/or welded connections to the stack, which can for example be realised by respective, the substrate extending ends with embedded rings to hold adhesives, or e.g. Ag rings, which during fusing melt into a sealing and contacting solder.

Recesses according to the present invention, in which sealing materials such as Ag rings can advantageously be inserted exactly fitting, simplify sealing of the connections between cell and stack, as if necessary, these rings can be held in place by the recesses during soldering of the cells into the stack, and thus sealing at the predefined locations can be realised without errors.

According to the present invention, extensions are another, sealing and the contact between cell and stack improving design feature, which are suitable for integration into an appropriate counter-shape of the stack (according to the key-lock-principle, e.g. via a plate adjacent to the substrate, which is fitted into a salient in the stack designated for the plate). A tapered shape, which can be connected with the appropriate tapered counter-shape in the stack, is mentioned here as an example.

If the design features according to the present invention, hence extensions, threads and/or recesses, are electrically conducting, then in addition the electrical contacting will be improved due to the increase in contact area between the cell and the current collecting unit of the stack (e.g. contact sheet). Therefore, the contact resistance is reduced. The design features or elements can be made of metal, ceramics and/or compositions of metal and ceramic (e.g. cermets). It is especially advantageous, if they are made of the same material as the substrate.

On the one hand these can be materials suitable for anodes, such as e.g. cermet based on a metal, advantageously nickel, and at least one ionic and/or electronically conducting ceramic. Examples for the ceramics are doped zirconium oxide (e.g. doped with yttrium and/or samarium and/or scandium) and/or doped cerium oxide (e.g. doped with gadolinium and/or scandium). Furthermore, metals, especially copper, cobalt and/or other transition metals and/or metal alloys can be included.

On the other hand, the material can also be suitable as cathode. In this case, among others, the following compounds can be used: Ferrites such as LSCF (lanthanum-strontium-cobalt-ferrite), manganites such as LSM (lanthanum-strontium-manganite) and LCM (lanthanum-calcium-manganite), nickelate, and/or cobaltite (e.g. LSC) or chromites (eg. Lanthanum strontium chromite). Compounds of the perovskite group are especially preferred. Metals, especially high-temperature alloys such as crofer 22 APU (X1CrTiLa22) are also considered as material for the substrate as electrically conducting carrier and thus, also for the design features.

Further important features and advantages of the invention result from subclaims, figures and corresponding figure descriptions.

The individual characteristics of the design examples, which are described in the following, can be realized independently from each other within the framework of the present invention, thus do not have to be exactly implemented in the characteristic combinations presented in the examples.

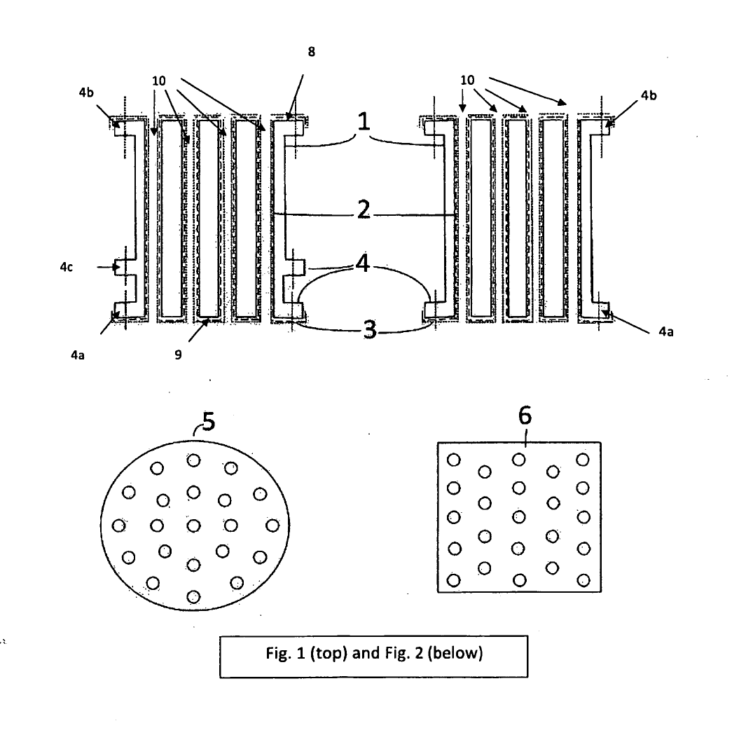

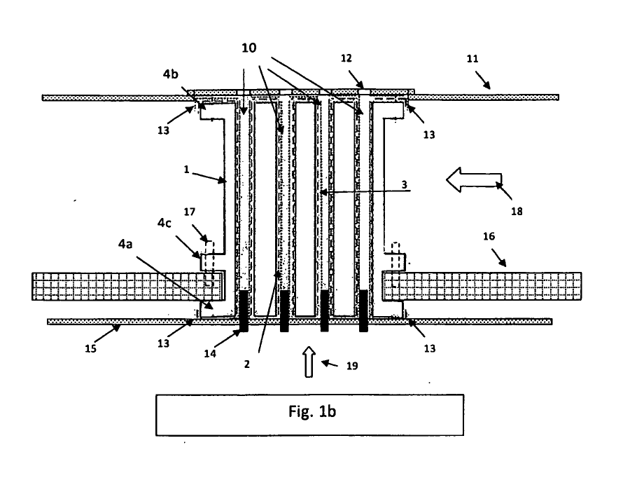

Preferred design examples of the invention are presented in the individual FIGS. 1 to 7 and will be explained in detail in the following description.

FIG. 1:

FIGS. 1 and 2 show solid oxide fuel cells (SOFCs) according to the present invention with tubular hollows (10) open on both sides in the substrate (1) which is used as one electrode whereby the hollows (10) lead to an increase of the effective surface and easier connection possibilities to the outer electrode surfaces, and complemented by constructional features (4), which simplify the integration into a stack (not shown here). FIG. 1 shows a cross section along the longitudinal axes of the hollows (10); FIG. 2 shows a cross section perpendicular to that.

The hollow walls are coated with the electrolyte (2) and the second electrode (3), whereas the electrolyte (2) is arranged so that no direct contact between the one electrode (2) and the other electrode (3) takes place. The substrate (1) coating with the second electrode (3) and the electrolyte (2) is in this implementation not only applied to the walls of the tubular hollows (10), but additionally also to the faces (8, 9) of the substrate (1). The basic cross section of the cells or the substrate can be both tubular (5) and any other geometry (e.g. square (6)).

The design features (4a, 4b, 4c) are extensions of substrate (1), which are perpendicular to the longitudinal axis of the hollows (10)and on which clamp-connections to the stack can be easily established or on which also adhesive, solder and/or welded connections to the stack can be easily realised without impacting the functionality of the stack. In the shown implementation, two of these design features (4a, 4b) are sideways ring-shaped arranged at both, here open ends of the substrate or respectively the hollows (10). In the implementation of FIG. 1 displayed on the left (round substrate cross section), an additional design feature (4c) can be found between design features (4a, 4b), which are arranged at both sides, however, it is arranged spatially closer to one of the outer design features, here to feature (4a) drawn at the bottom. This e.g. allows the application of solder to the porous substrate body without risking that the solder will reach the other electrode (3) and e.g. will cause cell-internal short circuits and/or poisoning effects. The variant shown on the right in FIG. 1 (square substrate cross section) only features one extension (4a, 4b) each at both open ends. FIG. 1b shows a possible cell integration utilizing the design features displayed in FIG. 1. Gas atmosphere (18) is supplied to the substrate (1) which is working as one electrode; atmosphere (19) supplies the other electrode (3). The top face of the cell is contacted with/hence connected to the discharge sheet/current collector (11) of the stack. This sheet contains holes (12) for the removal of the fluid (19). The bottom face of the cell is mechanically and electrically connected to the discharge sheet/current collector (15) of the stack. So in sum the second electrode (3) is electrically contacted by the sheets (11) and (15). Substrate (1) is contacted by discharge sheet/current collector (16), which is integrated between design features (4a) and (4c). By means of these several contacts the current paths within the cell are shortened and thus the ohmic drops are reduced.

At the circumferences of the faces (13) seals can be mounted to separate the different atmospheres (18, 19). These seals can be implemented by ceramic adhesives, pressure seals, glass solders and/or metal seals. Latter are preferred, as they reduce the contact resistance between the electrodes (1, 3) and the discharge sheets (11, 15, 16).

The gas supply to the inner electrode (3) via pipes (14), which preferably consist of an electrically conductive material, is realised at the lower face. Preferably these pipes (14) are soldered into the discharge sheet/current collector (15). This also increases the contact area between the electrode (3) and this discharge sheet.

It is also possible that these pipes completely or partially cover the inner electrode (3). In this case, especially for complete coverage, a gas exchange between the inside and outside of the pipes (14) must be ensured. This can be ensured by porous pipes or holes in the pipes. The substrate respectively the other electrode (1) are contacted to the conductivity sheet/current collector (16), whereat an increased surface for the electrical contact between the substrate (1) and the conductivity sheet (16) is enabled by design elements (4a) and (4c). The conductivity sheet (16) can either completely enclose the substrate (1) or can be arranged only at discrete locations of the substrate. For mechanical attachment and/or increase of the contact area between substrate (1) and sheet (16) pins, screws and other extensions (17) can be used.

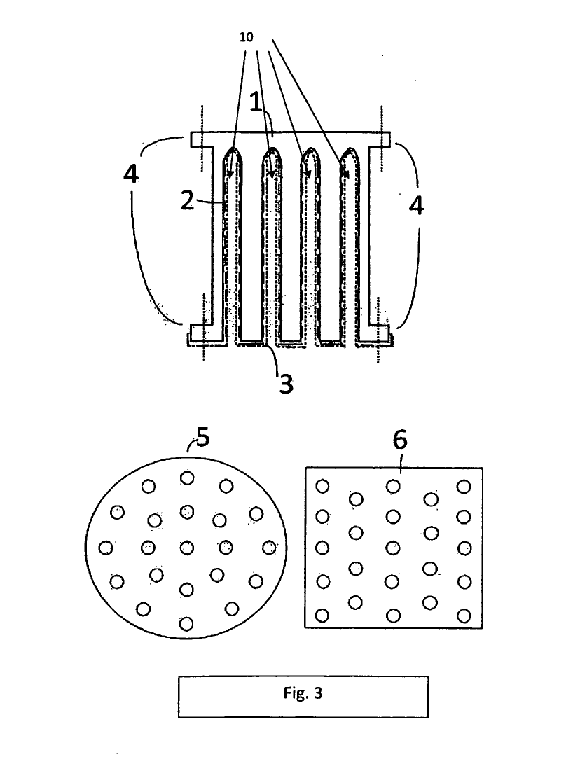

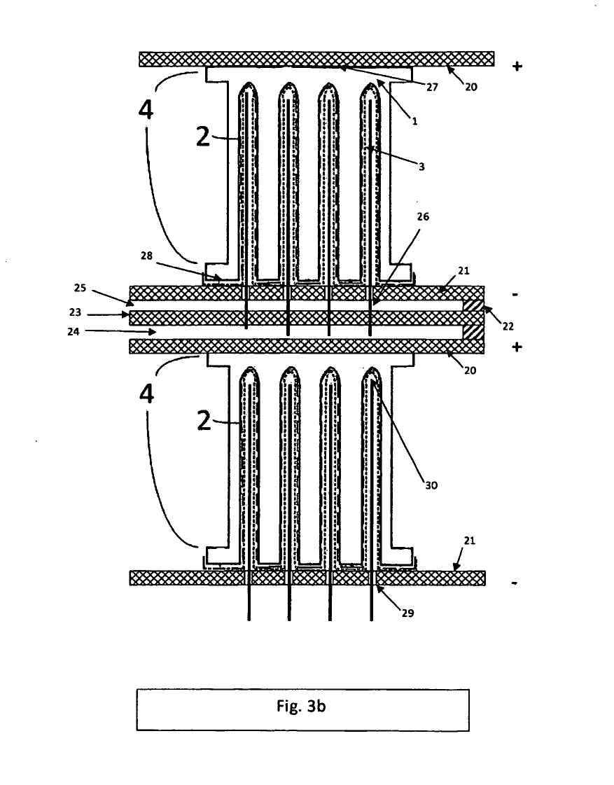

The additional FIGS. 3 to 7 each show examples according to the present invention, whose basic structure is consistent with the structure of the example shown in FIGS. 1, 1b and 2. Therefore, only the differences will be described below:

FIG. 3 shows one-sided closed SOFCs according to the present invention with many small tubular hollows (10) in the substrate (1) which is used as one electrode and whereby for an increase of the reactive surface the electrolyte (2) and the second electrode (3) are inserted into the hollows (10) and whereby for easier connection possibilities the electrode (3) and the electrolyte (2) are also situated at the outer substrate (1) surface at the bottom. The design features (4) simplify the integration into a stack (not shown). The basic cross section of the cells can be both tubular (5) and any other geometry (e.g. square (6)).

FIG. 3b shows an example of a possible arrangement of the fuel cells presented in FIG. 3. The top face (27) of the substrate (1), in this case the cathode, is here connected to a current discharge plate/current collector (20). The bottom face (28) is coated with the second electrode (3), here the anode, or an appropriate current-discharging material. With that the anode has electrical contact to the discharge plate/current collector (21). The discharge plates (21), (23) and (20), which are arranged on top of each other, are connected with each other via electrically conducting spacers (22), so that the two shown fuel cells are electrically connected in series. At the same time the spacers (22) ensure the generation of two hollow spaces (24) and (25), whereas (24) marks a channel for fuel supply and (25) marks a channel for the exhaust discharge of the second electrode (3).

First, the air supply for the anode occurs through channel (24); next fuel is supplied to the internal spaces (30) via pipes (26) incorporated into the discharge plate/current collector (23), which connect channel (24) and the internal spaces (30) of the hollows (10). The exhaust gas of the second electrode (in this case the anode) (3) moves via opening (29) in the discharge plate (21) to the exhaust compartment (25). Respective stringing together of several such fuel cells achieves a serial connection.

In this example, design features (4) only serve to increase the contact area between the electrodes (1, 3) and the discharge plates (20, 21) of the stack. An integration into the stack plates (20, 21) can also be realised accurately fitting, for example if stack plates (20, 21) feature recesses, in which the fuel cell can be inserted, or if screw connections and/or pins are attached to substrate (1), which can be inserted into the corresponding counter-shapes in plates (20, 21).

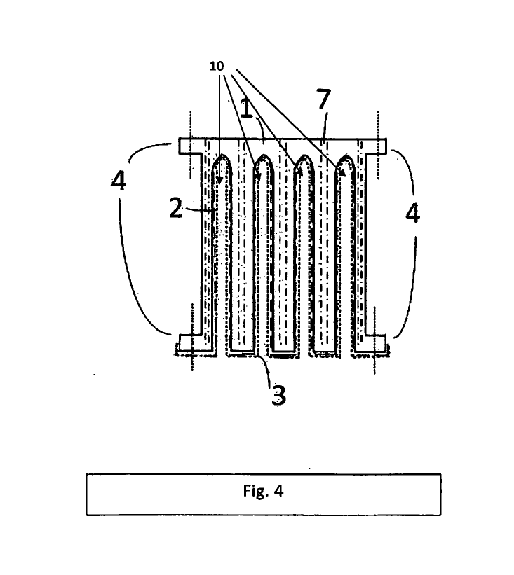

FIG. 4 shows the structure from FIG. 3 complemented by additional gas channels (7) in substrate (1), which is here realised as one of the electrodes.

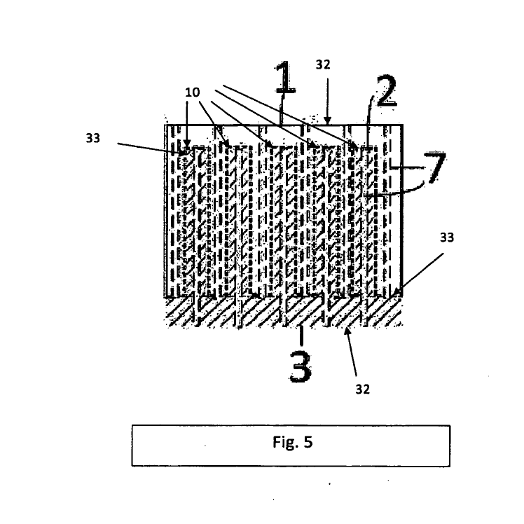

FIG. 5 shows a one-sided closed SOFC with many small tubular hollows (10) in substrate (1) inserted as first electrode, with additional gas channels (7), at which the second electrode (3) similar to the first one (1) is also realised as substrate and fitted into the hollows (10) of the first electrode (1), with the electrolyte (2) between both electrodes.

Gas channels (7) lead from the closed (massive) end (32) of the respective electrode to the open end (33). They preferably have a diameter between 0.1 mm and 3 cm. It is especially preferred to arrange the gas channels (7) parallel to the hollows (10) coated with the electrolyte to minimise the diffusion path of the gases through the electrodes.

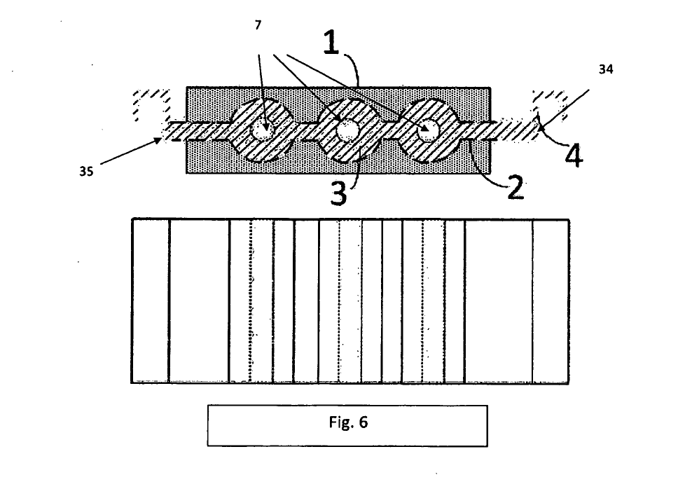

FIG. 6 shows a SOFC according to the present invention, with in this case three small hollows in substrate (1) inserted as first electrode with a square cross section, and a second electrode (3), which is similar to the first electrode (1) also realised as substrate and fitted into the hollows of (1), with the electrolyte (2) between both electrodes (1, 3), whereby the second electrode (3) contains additional gas channels (7). In addition, the second electrode comprises design features (4) for improved contacting and simplified integration into a stack (not shown here).

Here design feature. (4) is an electrically conductive extension of the second electrode (3) with a U-shaped cross section on the right (34) and left (35) end of the second electrode, at which the extension spans over the entire height of the electrode. In the internal space of the U-shape, discharge sheets/current collectors can be accurately fitted and sealed e.g. via clamp or solder connections, with large contact areas between discharge sheet and design feature and therefore low ohmic resistance.

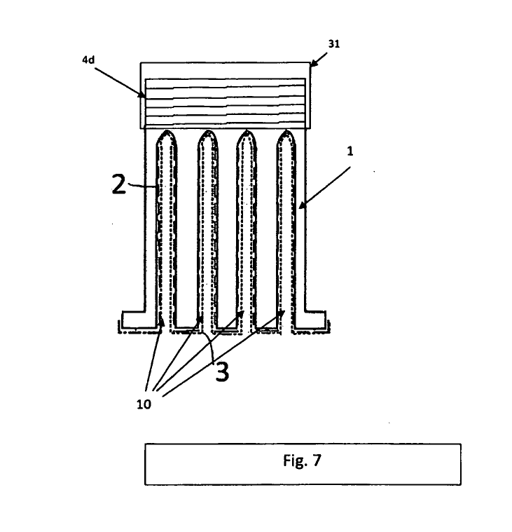

FIG. 7 shows a fuel cell comparable to the fuel cell in FIG. 3. In this case, one of the design features is implemented as a thread (4d) on the closed end of the tubular hollows, which is here inserted into a pipe (31) for gas supply and current collection of the substrate (1).

1. A solid oxide fuel cell, wherein one of the electrodes of the fuel cell or an electrically conductive carrier, on which this electrode is applied, is designed as stabilizing substrate (1), in which multiple tubular hollows with preferably round, oval and/or square cross sections and with at least one open end are arranged, wherein the hollows are coated with at least an electrolyte (2) and at least the other, second electrode (3) of the fuel cell, and wherein at least one constructional element, hereinafter also denoted as constructional feature, is arranged on or at and/or integrated into the substrate, said constructional element being adapted for the integration of the fuel cell into a reactor.

2. Fuel cell according to the preceding claim, wherein at least one of the constructional features is formed, moulded and/or arranged as follows: as an inner or outer thread integrated into the substrate (1) and/or attached to the substrate (1), and/or as an extension connected to the substrate (1), and/or adapted to create at least one clamp-connection and/or plug connection to the reactor, and/or adapted to create at least one adhesive, soldered and/or welded connection to the reactor, and/or adapted to be integrated into a respective counter-shape of the reactor, and/or electrically conductive and adapted to increase the electrical contact between the fuel cell and a current collector unit of the reactor by increasing the contact area between the fuel cell and this current collector unit of the reactor and thus by reducing the respective contact resistance of this electrical contact, and/or as a recess integrated into the substrate, which is preferably adapted to simplify sealing of a connection between the fuel cell and the reactor.

3. Fuel cell according to one of the preceding claims,
characterised in that
seen perpendicularly to the longitudinal direction of the hollows, the substrate has a round, oval or polygonal, especially rectangular or square, cross section,
and/or
characterized by multiple parallel and/or channel-like hollows.

4. Fuel cell according to one of the preceding claims, characterised in that the substrate comprises additional gas channels, which are preferably arranged in parallel with and with an offset to the hollows and/or which are preferably tilted in an angle between 1 and 91° relative to a centre axis of the hollows.

5. Fuel cell according to one of the preceding claims
characterised in that
the second electrode (3) is manufactured as a substrate and adapted to the hollows of the first electrode,
wherein preferably the second electrode is exactly fitted into the hollows of the first electrode, the first and the second electrode being separated from each other and connected with each other by the electrolyte (2) located in-between the first and the second electrode.

6. Fuel cell according to claim 5, characterised in that also the second electrode (3) comprises at least one constructional feature as is described in claim 1 which is designed for the integration into the reactor, wherein preferably this at least one constructional feature is realized according to claim 2.

7. Fuel cell according to claim 5, characterised in that the second electrode comprises gas channels, preferably tubular gas channels with round and/or oval and/or square cross sections, which, preferably arranged in parallel, lead from the gas inlet of the second electrode to the opposing end of this electrode or are only arranged in a partial section of this electrode, and/or which are tilted in an angle between 1 and 91° relative to a centre axis of the hollows.

8. Fuel cell according to one of the preceding claims, characterised in that the substrate and/or the second electrode is/are manufactured by injection moulding, by casting in lost moulds or in permanent moulds or by extrusion.

9. Fuel cell according to one of the preceding claims, characterised in that the constructional feature(s) together with the substrate serving as electrode and/or electrically conductive carrier, is/are manufactured in one and the same manufacturing step, preferably in a casting step, preferably in an injection moulding step.

10. Fuel cell according to one of the preceding claims 1 to 8, characterised in that the constructional feature(s) is/are retroactively attached to the substrate serving as electrode and/or electrical carrier, preferably by bonding, soldering, pressing, plugging and/or welding.

11. Fuel cell according to one of the preceding claims,
characterised in that
the material or parts of the material of the constructional element(s) and/or the substrate are adapted to be used as anode material and/or conductor at the side of the anode for solid oxide fuel cells,
and/or
in that said material or said parts comprise(s) or consist(s) of a metal, a metal alloy, a ceramic or a compound of at least one metal or one metal alloy and at least one ceramic.

12. Fuel cell according to the preceding claim,
characterised in that
at least one of the metals is a metal of the transition elements, preferably an element of the 5^{th}, 6^{th}, 7^{th}, 8^{th}, or 1^{st} subgroup (transition group), preferably nickel, copper, iron, cobalt, molybdenum or chromium, or a precious metal, preferably silver, platinum, palladium, rhodium, iridium or gold,
and/or
that the ceramic comprises or consists of an ionic and/or electronically conductive ceramic with a fluorite or perovskite structure, wherein the ceramic preferably comprises or consists of a ceramic from the group of the doped zirconium oxides and/or the doped cerium oxides and/or the doped bismuth oxides and/or the doped gallates,
and/or
that the electrically conductive carrier comprises or consists of a steel or a superalloy, advantageously based on Mn, W, Co, Al, Ni, Fe, Cr, Mo, Re, Ti, Zr, Ru, Ta, Nb, B and/or C.

13. Fuel cell according to one of the preceding claims, characterised in that the material or parts of the material of the constructional element(s) and/or the substrate is/are adapted to be used as cathode material and/or conductor at the side of the cathode for solid oxide fuel cells and/or comprise or consist(s) of a ceramic and/or a metal.

14. Fuel cell according to the preceding claim,
characterised in that
the metal is a metal and/or alloy which is at least partly stable against oxidation under operating and manufacturing conditions of the fuel cell,
and/or
that the metal contains a precious metal, especially silver, platinum, palladium, rhodium, iridium or gold, and/or a high-temperature alloy, especially a high-temperature steel or a superalloy, advantageously based on Mn, W, Co, Al, Ni, Fe, Cr, Mo, Re, Ti, Zr, Ru, Ta, Nb, B and/or C,
and/or
that the ceramic comprises or consists of at least one ionic and/or electronically conductive compound, which is preferably selected from the compound class of the perovskites and/or the group of doped ferrites and/or doped manganites and/or doped cobaltites and/or doped chromites and/or doped nickelates,
and/or
that the ceramic comprises a combination of one of the previously mentioned compounds with a doped zirconium oxide and/or a doped cerium oxide and/or a doped bismuth oxide and/or a doped gallate.

15. Fuel cell according to one of the preceding claims, characterised in that the material of the constructional elements(s) and/or the substrate is adapted to be used as electrically conductive carrier material and that it advantageously comprises a high temperature alloy.

16. Fuel cell according to one of the preceding claims, characterized in that the constructional element(s) and the substrate comprise(s) or consist(s) of one and the same material or one and the same material combination.
